(19) United States
(12) Patent Application Publication
(10) Pub. No.: US 2005/0271859 A1
(43) Pub. Date: Dec. 8, 2005

(54) Nanostructure aluminum fiber metal laminates

(75) Inventors: Gary D. Tuss, Bellevue, WA (US); Sven E. Axter, Bellevue, WA (US); Clifford C. Bampton, Canoga Park, CA (US)

Correspondence Address: BLACK LOWE & GRAHAM PLLC, 701 FIFTH AVENUE, SUITE 4800, SEATTLE, WA, 98104, US

(73) Assignee: The Boeing Company

(21) Appl. No.: 11/072,851

(22) Filed: Mar. 3, 2005

Related U.S. Application Data
(63) Continuation-in-part of application No. 10/775,564, filed on Feb. 10, 2004.

(51) Int. Cl. B32B 5/12

(52) U.S. Cl. 428/113; 428/116

(57) ABSTRACT

Nanostructure aluminum fiber-metal laminates are disclosed. In one embodiment, a laminate includes a nanostructure aluminum metal layer bonded to a fiber layer. In another embodiment, the nanostructure aluminum metal layer may be produced by mechanically alloying an aluminum alloy powder submerged in a liquid nitrogen solution. Alternately, a plurality of fiber layers may be disposed between a pair of nanostructure metallic layers. The laminate may be cured at optimal temperatures that do not affect the properties of the composite. In another embodiment, a hollow core may be incorporated between structure aluminum fiber-metal laminate assemblies.

### BACKGROUND OF THE INVENTION

Equipment, such as in aircraft, commonly use aluminum alloys for structure and skin material. Because it is desirable to reduce the weight of an aircraft, use of lightweight composite materials has also become common. These lightweight composites include fiber metal laminates (FML), which have recently been developed utilizing carbon and glass fiber layers interspersed between layers of aluminum or other metals. Fibers such as glass often may not have a sufficiently high modulus of elasticity to produce a laminate able to carry significant loads without potentially over-stressing or fatiguing the aluminum layers when the laminate is under repeated loading. Additionally, conventional FMLs utilize thermal processing during curing of the composite to develop strength characteristics in the material, which may cause a loss of properties at high, yet optimal, temperatures. Currently, conventional methods employ a lower but less than optimal temperature to cure the composite and avoid the risk of loss in the property of the materials. Further, the risk of loss in properties because of the high temperature curing, especially in aluminum alloys, prevents efficient repair of the material in service at these higher temperatures.

### SUMMARY OF THE INVENTION

The present invention is directed to nanostructure aluminum fiber metal laminate composites. Embodiments of the present invention may provide an effective solution to strength character issues by providing relatively elastic materials with increased strength and structural weight savings capabilities. Furthermore, embodiments of the present invention may reduce the loss of property associated with thermal heating in the curing process by employing a heat-resistant metal material that is not substantially affected by high temperatures. Embodiments of the present invention may advantageously provide laminates and components with physical properties and corrosion resistance in the aerospace industry and any other industry where composite laminates are important.

In one embodiment, a nanostructure aluminum fiber metal laminate composite of the present invention comprises a plurality of nanophase aluminum metal layers and a plurality of fiber layers. The composite is formed by pretreating the nanostructure metal layer and interspersing it with respect to the fiber layer. Interspersing may be done with complete layers of the nanostructure metal and fiber layers, as well as with partial layers of either the nanostructure metal or fiber layer pieced throughout the composite to form an area of increased percentage of either metal or composite to tailor locally the desired properties. The layers are then bonded to one another to form the nanostructure aluminum fiber metal laminate composite. Because the nanophase aluminum material properties do not degrade at elevated temperatures, the composite may be cured at relatively high temperatures without risk of loss of desirable physical properties. Finally, the composite forms a hollow core layer between nanostructure aluminum fiber metal laminate composite layers.

### BRIEF DESCRIPTION OF THE DRAWINGS

Preferred and alternate embodiments of the present invention are described in detail below with reference to the following drawings.

FIG. 1 is a cutaway isometric view of a nanostructure aluminum fiber metal laminate according to an embodiment of the present invention;

FIG. 2 is a cutaway isometric view of a nanostructure aluminum fiber metal laminate according to an alternate embodiment of the present invention;

FIG. 3 is a cross-sectional view of a nanostructure aluminum fiber metal laminate according to a further embodiment of the present invention;

FIG. 4A is an isometric view of a nanostructure aluminum fiber metal laminate with a honeycomb core layer according to another embodiment of the invention;

FIG. 4B is a cross-sectional view of a nanostructure aluminum fiber metal laminate aircraft fuselage segment including a honeycomb core layer according to yet another embodiment of the invention;

FIG. 5 is a block diagrammatic view of a method for forming a fiber metal laminate in accordance with still another embodiment of the invention;

FIG. 6 is a cross-sectional view of a nanostructure aluminum fiber metal laminate according to yet another embodiment of the invention; and

FIG. 7 is a block diagrammatic view of a method of producing a fiber metal laminate according to an alternate embodiment of the invention.

### DETAILED DESCRIPTION

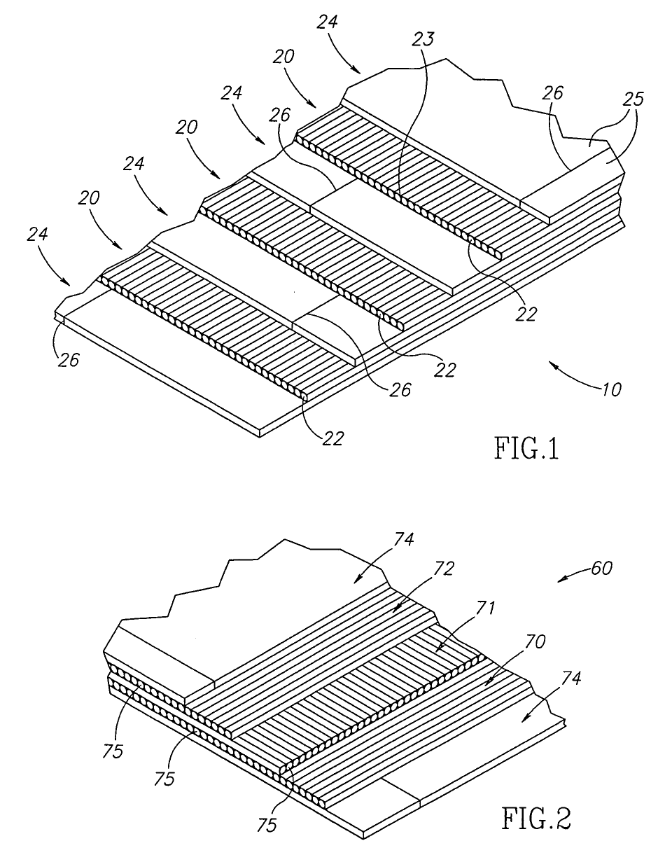

The present invention relates to nanostructure aluminum fiber-metal laminate composites. Many specific details of certain embodiments of the invention are set forth in the following description and in FIGS. 1 through 7. One skilled in the art, however, will understand that the present invention may have additional embodiments, or that the present invention may be practiced without several of the details described in the following description.

In general, embodiments in accordance with the present invention may advantageously provide increased structural weight savings and may reduce the loss of desirable material properties (e.g. strength) during thermal curing associated with fabricating, maintaining, and repairing fiber-metal laminate composites. Because embodiments of the present invention are adapted to handle a variety of weight stresses and curing temperatures, multiple configurations may be suitable for use.

FIG. 1 is a cutaway isometric view of a nanostructure aluminum fiber metal laminate 10. In this embodiment, the nanostructure aluminum fiber metal laminate 10 includes nanophase metallic layers 24 interspersed and bonded to fiber layers 20. As used herein, the term nanophase (or nanostructure) generally refers to metals containing nanoscale crystallite structures. Such nanoscale crystallite (grain) structures may, for example, have an average dimensional size (e.g. diameter) of approximately 1-500 nm or more.

In one particular embodiment, the nanostructure alloy may comprise a cold-rolled aluminum-alloy thin sheet or foil of aluminum-based material having an ultrafine, submicron grain structure, i.e. an average grain size of less than 500 nanometers. In some embodiments, the strength and physical properties of the aluminum alloy foil may be constructed by utilizing a cryogenic milling process (or cryomilling), as disclosed, for example, in U.S. patent application Ser. No. 10/772,690 by Fritzemeier et al., U.S. patent application Ser. No. 10/388,059 by Van Daam and Bampton, U.S. patent application Ser. No. 10/348,841 by Bampton and Wooten, and U.S. patent application Ser. No. 10/263,135 by Fritzemeier et al., which applications are incorporated by reference herein, and as will be described more fully below. By utilizing the cryomilling process, the nanophase aluminum may be produced in the form of a cold-rolled aluminum-alloy thin sheet or foil, comprised of an aluminum-based material having an ultra-fine, submicron grain structure, i.e. an average grain size of less than 500 nanometers.

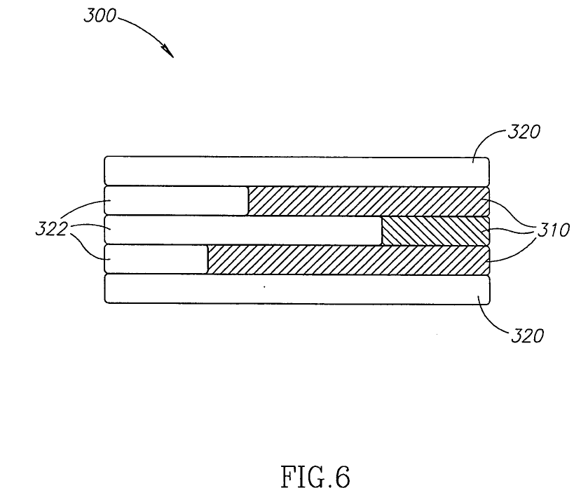

Still referring to FIG. 1, the metallic layers 24 may include butt joints 26 between sheet sections 25 within the metallic layers 24. The fiber layers 20 may also include butt-jointed sections (not shown) to permit the laminate 10 to be manufactured in large sheets, depending on the planned application for the laminate 10. Suitable nanostructure aluminum for the metallic layers 24 include heat-resistant nanophase aluminum, or any other suitable heat-resistant nanophase materials. In one particular embodiment, the nanophase metallic layers 24 and the fiber layers 20 are present in the laminate 10 in an approximately equal or 1:1 ratio (e.g. in FIG. 1, there is one more layer 24 than layer 20). In various alternate embodiments, any number of layers may be provided as desired for a particular application, including multiple fiber layers 20 interspersed between each metallic layer 24 (e.g. FIG. 2). In further embodiments, a laminate in accordance with the present invention may include a variety of complete layers interspersed with partial layers pieced throughout the laminate to serve as an area of higher volume fraction of either metallic or composite material in order to locally improve specific mechanical properties (e.g. FIG. 6).

Use of the nanophase metallic layers 24 in conjunction with the fiber layers 20 may allow for the use of fewer or no cross-plys in comparison with prior art fiber composite laminates. This may be particularly true for structures and skins that are primarily under tensile loads. The metallic layers 24 can carry stress about equally in all directions in the plane of the metallic layer 24, while the fiber layers 20 typically exhibit substantially higher strength in a direction generally parallel to the fibers 22. Metallic layers 24 in the laminate 10 also add benefits of electrical conductivity, a moisture barrier, resistance to weather, and damage tolerance in comparison with the prior art. The metallic layers 24 may exhibit greater resistance to sharp objects than a fiber layer 20 alone, and typically show visible impact damage when impacted by other objects. In one particular embodiment as shown in FIG. 1, the fiber layers 20 include fibers 22 that are substantially aligned in the same direction. It will be appreciated that in areas requiring high shear stiffness, for example such as aircraft wings and some fuselage areas, the fibers 22 may be aligned at any angle relative to each other or to the plane of the layer 20, including 45° to a primary stress direction.

In one embodiment, fiber layers 20 include very high modulus of elasticity polymer fibers that are not galvanically reactive with aluminum. The high modulus fibers 22 carry most of the stress applied to the laminate 10, while minimizing over-stressing and fatigue to the metallic layers 24. In one particular embodiment, the very high modulus non-reactive polymer fibers permit the laminate 10 to be only 10 percent to 40 percent metal by weight. In an alternate embodiment, for areas such as structural joints, for example, where additional multidirectional stress carrying capacity for complex loading is desired, the laminate 10 may be 10 percent to 50 percent metal by volume.

In another embodiment, the fiber layers 20 may include a resin matrix 23 (FIG. 1) that is interspersed between and holds the polymer fibers 22. The resin matrix 23 may be a thermo-hardening material that permits heat cure of the laminate. In various alternate embodiments, the resin matrixes may include thermal curing epoxies and resins such as the 3900-2 epoxy commercially available from Toray Industries, Inc. of Tokyo, Japan, the CYCOM® 934 epoxy resin commercially available from Cytec Engineered Materials of Greenville, Tex., and the F155 prepreg material available from the Hexcel Corporation of Pleasanton, Calif. The resin matrixes may also include adhesives, such as the bismaleimide-based adhesive 5250-4 available from Cytec Engineered Materials, and may also include cyanate esters, such as the PN-900 products commercially available from Stesalit AG of Zullwil, Switzerland. The matrix resins may typically be heat cured. The resins may be formed with the fibers 22 into pre-assembled pre-impregnated layers (“pre-pregs”), often including multiple layers of the fibers 22. Multiple pre-pregs (not shown) may form a fiber layer 20.

In one particular embodiment, the laminate 10 comprises very high modulus non-reactive polymer fibers 22 with moduli of elasticity over 270 Gpa, including without limitation poly 2,6-duimidazo [4,5-b4′,5′-e] pyridinylene-1,4 (2,5-dihydroxy) phenylenes (“PIPD”), such as M5® fiber, manufactured by Magellan Systems International, with a modulus of elasticity over 300 GPa. An alternate non-reactive very high elastic modulus polymer includes poly (p-phenylene-2,6-benzobisoxazole) (“PBO”), such as ZYLON®, manufactured by Toyobo Co., Ltd of Osaka, Japan. The fibers 22 are typically assembled in alignment and embedded in a resin matrix to form fiber layers 20.

In yet another embodiment, the metallic layers 24 are bonded to the fiber layers 20 during assembly of the laminate 10. The fiber layers 20 suitably may bond themselves to the metallic layers 24 when the laminate 10 is assembled and held under pressure during heat curing. However, bond strengths between the fiber layers 20 and the metallic layers 24 can be enhanced if desired, by way of example and not limitation, by pre-treatment of the metallic layers 24 and by using a separate adhesive between the metallic layers 24 and the fiber layers 20. Suitable optional adhesives for increasing bond strength if desired between the fiber layers 20 and the metallic layers 24 include heat cured epoxies, such as without limitation the MSR-355 and MSR-351 products available from Applied Poleramic, Inc. of Benicia, Calif. These epoxies may serve as an interphase adhesive between the fiber layers 20 and the metallic layers 24.

The metallic layers 24 themselves suitably may be pre-treated to increase adhesion to the fiber layers 20, thereby increasing the strength and durability of the laminate 10. Pre-treatments suitably may include a wide variety of metallic pre-treatments including, for example, acid or alkaline etching, conversion coatings, phosphoric acid anodizing, and any other suitable pre-treatment. Such pre-treatments may increase surface roughness, thereby facilitating a stronger physical bond with the adhesive, or may facilitate a better chemical bond with the adhesive. In one particular embodiment, a further alternate pre-treatment of applying a sol-gel coating to the metallic layers 24 may be utilized prior to assembly of the laminate 10. The sol-gel process may use an inorganic or organo-metallic pre-cursor to form an inorganic polymer sol. Sol-gel coatings may include zirconium-silicone coatings, such as those described in U.S. Pat. Nos. 5,849,110, 5,869,140, and 6,037,060 issued to Blohowiak, et al., which patents are hereby incorporated by reference. The resulting inorganic polymer sol coating may advantageously serve as an interphase layer between the metal layers 24 and the fiber layers 20 when they are bonded together. Pre-treatments may also include grit blasting. Grit blasting may also suitably cold work the alloys in the metallic layers 24. Further exemplary pre-treatments suitably may include heat treatment and wet honing.

It will be appreciated that including the metallic layers 24 in the laminate 10 may advantageously permit all of the fibers 22 of the fiber layers 20 to be in alignment. It will also be appreciated that including the metallic layers 24 in the laminate 10 may advantageously permit all of the fibers 22 of the fiber layers 20 to be in alignment with the direction of the maximum stress. In some types of prior art composites that do not include the metallic layers 24, approximately 10 percent of the fibers are oriented 90° to the primary axis of stress. The 10 percent of the fibers oriented at 90° to the primary axis of stress are necessary to prevent disintegration in shear of the composite. In accordance with embodiments of the invention, however, when the metallic layers 24 are combined with the fiber layers 20, such as the high elastic modulus, non-reactive polymer fibers 22, as low as 0 percent of the fibers 22 may be oriented at 90° to the primary stress. Thus, a laminate 10 with all of the fibers 22 aligned in a common direction advantageously may be assembled and utilized without the added materials and manufacturing steps of including cross-plys.

In one embodiment, the fiber layers 20 are interspersed between the metallic layers 24 by applying an adhesive (not shown) at each boundary between a metallic layer 24 and a fiber layer 20. The resulting stack is placed in a vacuum bag. The vacuum bag is placed into an autoclave. A vacuum is applied to the vacuum bag, and the autoclave is pressurized. The autoclave is heated to and held for a sufficient amount of time at a temperature suitable to activate and cure the adhesive (not shown) and the resin matrix (not shown) thereby curing the laminate 10. It will be appreciated that the temperatures and hold times for the autoclave correspond to those suitable for cure of the adhesive (not shown) and the resin matrix (not shown). In the present embodiment, temperature and heat time do not affect the heat-resistant nanostructure aluminum fiber metal laminate composite.

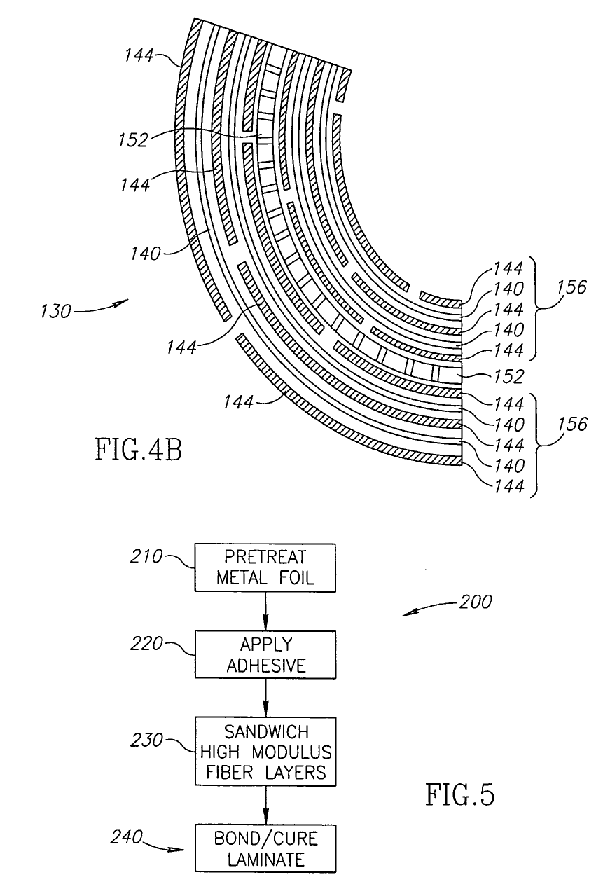

In one embodiment, curing is performed with a resin matrix (not shown) having a 350° F. cure resin, such as the 3900-2 resin available from Toray Industries. The autoclave is then heated to approximately 350° F. and held at that temperature for approximately 120 minutes. Typical cure temperatures for heat curing resin adhesives and matrix resins include cures between 250° and 350° F.±10° for approximately two hours. It will be appreciated that heat curing of the adhesive (not shown) in the matrix resin (not shown) may also simultaneously heat treat or heat age the metallic layers 24, although the nano-aluminum alloy does not age and recovers all of its strength on cooling back to ambient temperatures. It will also be appreciated that during forming, the laminate 10 may be formed over a form or in a complex shape prior to cure. This permits the laminate 10 to be formed and cured into curved or segmented shapes such as a curved section described below in connection with FIG. 4B.

As described above, one or more of the nanostructure metallic layers 24 may be formed using a cryomilling process. For example, in one particular embodiment, a cryogenic milling process comprises mechanical alloying of metal powders in a liquid nitrogen slurry, with aluminum-alloy powders, thereby producing ultra-fine grain nanocrystalline-alloy materials. The cryomilling process may produce a high-strength, extremely ultra-fine, thermally stable grain size material powder. After the cryomilled metal-alloy powder has been degassed and consolidated through a Hot Isostatic Pressing (i.e., HIP) or ‘Ceracon-type’ forging process, or other applicable degassing method, the resulting nanocrystalline ultra-fine grain microstructure may be substantially homogeneous. Once the homogeneous, cryomilled powder material has been consolidated, it may be extruded or drawn into various shapes that can be used as starting material for a thin sheet or foil material. In one embodiment, the aluminum-alloy may be cold-worked or hot-worked from the starting consolidated cryomilled material into the form of a sheet or foil. This work is advantageously performed by a rolling mill using rolling mill techniques known in the art.

Making use of the cryomilled aluminum-alloy sheet may eliminate the need for thermal treatment, including water quenching. In contrast, previous manufacturing practices call for considerable efforts involving several additional processing steps to be taken in the heat-treatment processing of aluminum-alloy materials in order to ensure that the resulting material has the desired strength level. In one embodiment of the present invention, the use of cryomilling may avoid residual stresses and distortion present in the sheet or foil material. Conventional aluminum alloys that are not used in an age-hardened (water quenched) condition, such as aluminum alloy 5083, for example, typically have tensile strengths of about 45 ksi or lower. Cryomilling the aluminum alloy to submicron grain sizes may significantly increase the tensile strength to, for example, approximately 90 ksi for the same alloy (5083).

Binary, tertiary, or multi-component aluminum-alloys may be used with the invention, including but not limited to 5083, 2017-T3, 2117-T3, and 7050-T73 alloys. In one embodiment, if the beginning metal powder is supplied as pre-alloyed powder, then it may proceed directly to the cryomilling process. Metal powders that have not been previously alloyed may also proceed to the cryomilling step since the cryomilling may intimately mix the constituents and thereby alloy the metals.

In one particular embodiment, the aluminum alloy may be composed of at least approximately 50% aluminum by weight in combination with one or more alloying elements. Suitable alloying elements include, for example, copper, magnesium, zinc, zirconium, lithium, silicon, titanium, and other suitable alloys, including combinations thereof. For example, in one particular embodiment, the alloy may comprise approximately 89 atomic % to approximately 99 atomic % aluminum and approximately 1 atomic % to approximately 11 atomic % of a secondary metal. Suitable secondary metals include, for example, magnesium, lithium, silicon, titanium, zirconium, and combinations thereof. One will appreciate, however, that other suitable secondary metals and combinations thereof may also be selected. In another embodiment, the alloy may also include up to approximately 10 atomic % of a tertiary metal. Suitable tertiary metals include, for example, Be, Ca, Sr, Ba, Ra, Sc, V, Cr, Mn, Fe, Co, Ni, Cu, Zn, Y, Nb, Mo, Tc, Ru, Rh, Pd, Ag, Cd, W, and combinations thereof.

Further, the cryogenic milling process may include controlled temperature and the controlled introduction of liquid nitrogen. In one embodiment, the liquid nitrogen may contribute to the formation of nitrides of aluminum. For example, the mill may be maintained at approximately −320° F., which may include mechanically alloying metal powders while they are submerged in liquid nitrogen. The resulting cryomilled aluminum alloy foil may have improved material properties, the majority of which may directly depend upon the ultra-fine submicron grain microstructure, in comparison over currently fabricated components in which additional thermal or heat treatment steps may be necessary to impart the desired mechanical properties.

In FIG. 2, an alternate embodiment of a laminate 40 is shown in cutaway isometric view. Like the laminate 10 in FIG. 1, the laminate 40 in FIG. 2 includes nanostructure aluminum metallic layers 74 and interspersed fiber layers 70, 71, 72 interspersed between the metallic layers 74. Any number of layers may be provided as desired for a particular application, including multiple fiber layers 70, 71, 72 interspersed between each metallic layer 74.

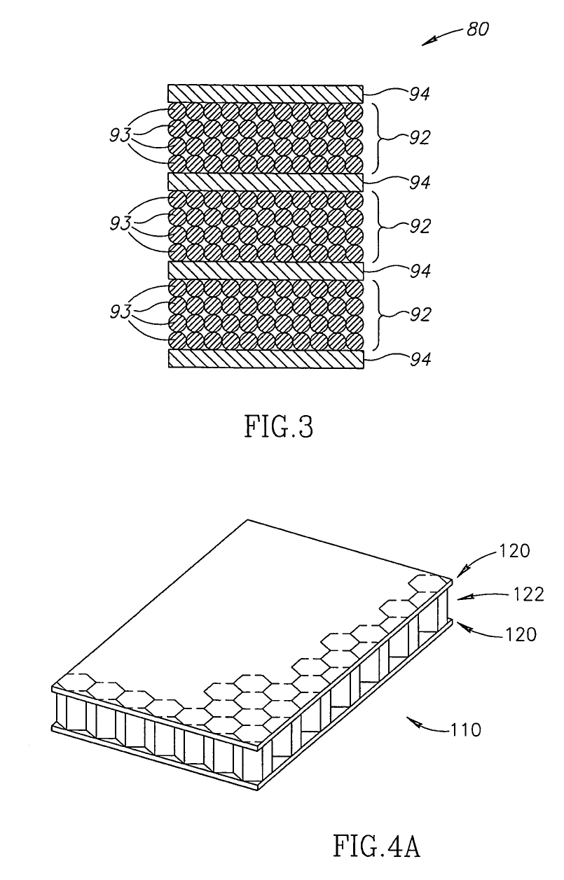

FIG. 3 is a cross-sectional view of a nanostructure aluminum fiber metal laminate 80. In this embodiment, each multi-tier fiber layer 92 includes a plurality of tiers or layers of fibers 93 that are all in common alignment and interspersed between each metallic layer 94. In another embodiment, the plurality of tiers or layers of fibers may be aligned in alternating directions such that one layer is aligned in one direction and the next layer is aligned in a different direction.

The materials and assembly methods used for the laminate 80 may be those as described above in reference to FIG. 1. In various alternative embodiments, it may be advantageous for one or more of the metallic layers of the laminate to be thicker than the other layers. Thicker metallic layers may, for example, provide additional lightning protection when incorporated on the outside of the laminate 80, may provide additional thickness for landing fasteners, brackets, or other connections; or may provide additional thickness for later chemical or conventional machine milling to form more complicated surface configurations and thicknesses.

It will be appreciated that a hollow core layer may be incorporated into a high modulus nanostructure aluminum fiber-metal laminate. FIG. 4A is an isometric view of a nanostructure aluminum fiber metal laminate 110 with a hollow core, including a partially “hollow” or “honeycomb” core layer 122 sandwiched between two nanostructure aluminum fiber metallic composite layers 120, as described in FIGS. 1 through 5 above. In one embodiment, the hollow core layer 122 is a hexagonal-celled honeycomb layer 122. Such honeycomb layers 122 may include, for example, aluminum honeycombs manufactured by Hexcel Corporation. In another embodiment of the present invention, the honeycomb core may also comprise of nano-aluminum foil. It will be appreciated that incorporating a hollow core layer 122 into a fiber metal laminate 110 may increase the stiffness of the laminate 110.

The high modulus fiber laminate of the present invention may be incorporated into aircraft components. FIG. 4B is a cross-sectional view of a nanostructure aluminum fiber metal laminate aircraft fuselage segment 130 including a honeycomb core layer 152. The fuselage section 130 is formed into a partially-cylindrical or partially-conical shape (shown here in two-dimensional cross section), as desired for a particular application. In this particular embodiment, the fuselage section 130 includes a hollow core layer 152 sandwiched between high modulus fiber layers 140 and metallic layers 144 that are all assembled and cured into one pre-formed fuselage section 130. On alternative sides of the hollow core layer 152 is a multi-layer fiber metal laminate assembly 156. By way of example, each assembly 156 may include three metallic layers 144 of butt joined nanostructure aluminum and two fiber layers 140. The fiber layers 140 are then interspersed between the metallic layers 144 in accordance to the assembly and manner described in reference to FIG. 1 above. It will be appreciated that having a metallic layer 144 at the outside and inside of the fuselage section 130 suitably adds moisture protection, damage resistance, and weather resistance to the assembly, as well as provide electromagnetic effects (EME) protection from events such as lightning and bonding and grounding paths for electrical equipment.

FIG. 5 is a block diagrammatic view of a method for forming a fiber metal laminate of the present invention. In one present embodiment, a method 200 of assembling the nanostructure aluminum fiber metal laminate begins at a block 210 at which nanostructure aluminum metallic layers are pre-treated. Pre-treatments at the block 210 include pre-treatments such as sol-gel coating, as described in reference to FIG. 1 above. After pre-treatment of the metallic layer, adhesive is applied to areas that will form junctions between the metal and fiber layers at a block 220. At a block 230 the laminate assembly is laid up by interspersing fiber layers between nanostructure aluminum metallic layers. At a block 240 the laminate is cured in a manner described in reference to FIG. 1 above. Curing typically includes heat curing. This results in bonding of the high modulus fiber layers to the metallic layers thereby forming the fiber metal laminate of the present invention.

Now referring to FIG. 6, a cross sectional view of a nanostructure fiber laminate 300 is shown. In this embodiment, a nanostructure fiber laminate 300 composite includes complete nano-metallic layers 320 and partial nano-metallic layers 322 spliced with alternating discontinuous fiber layers 310. In another embodiment, complete fiber layers 310 and partial fiber layers (not shown) may be spliced with alternating discontinuous nano-metallic layers 320. Splicing complete nano-metallic layers 320 and partial nano-metallic layers 322 with alternating discontinuous fiber layers 3.10, for example, may be present in a single composite layer to change the volume fraction of either material, thereby locally optimizing the mechanical properties of the composite.

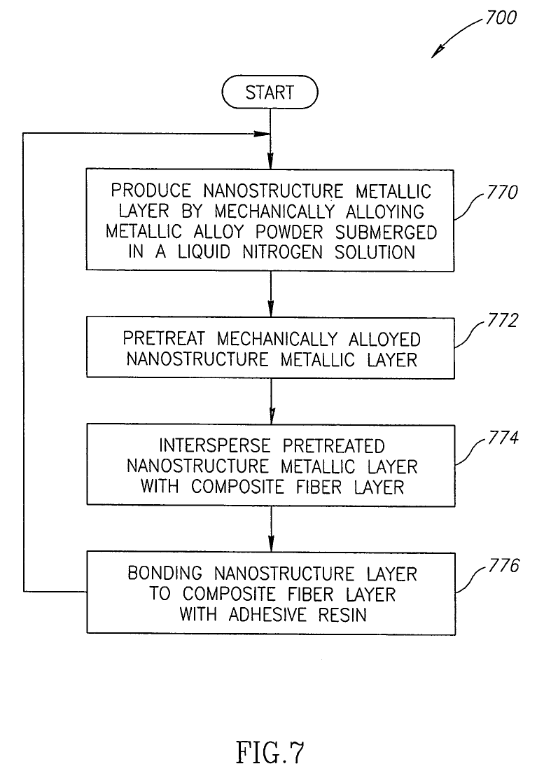

FIG. 7 shows a block diagrammatic view of a method 700 of producing a nanostructure composite laminate. At a block 770, a nanostructure metallic layer may be produced by any suitable process. In the embodiment shown in FIG. 7, the nanostructure metallic layer is produced by mechanically alloying a metallic alloy powder, including aluminum alloy powder for example, submerged in a liquid nitrogen solution. In one embodiment, the mechanical alloying in liquid nitrogen may be performed by cryomilling, as described in detail above in connection with FIG. 1. Suitable nanostructure metallic layers may comprise of nanophase aluminum, but other suitable nanophase metallic alloys may be applicable. After the nanostructure metallic layer is produced, it is then pretreated at a block 772 with treatments as described in detail above in connection with FIG. 5. For example, pretreatment of the nanostructure metallic layer may include sol-gel coating, as well as other suitable methods of treatment as previously described. The pretreated nanostructure metallic layer is then interspersed at a block 774 with a composite fiber layer, which may comprise a plurality of fibers. Finally, the nanostructure metallic layer is bonded at a block 776 to the composite fiber layer with an appropriate adhesive resin, including epoxy resins and other suitable resins, in addition to applicable bonding methods as described above.

Embodiments of the present invention may provide significant advantages over prior art fiber metal laminate composites. For example, embodiments of the present invention may reduce or eliminate the loss of property problems typically associated with heat curing of composites because of the inclusion of heat-resistant nanostructure aluminum materials. Current thermal processes for aluminum alloys utilize a curing range of approximately 250-350 F. The strength benefits, however, gained from this thermal processing may be lost if the material is exposed to temperatures in excess of 300 F for an extended period of time. In one embodiment, the thermally stable nanostructure aluminum materials may be cured relatively higher temperatures than traditional aluminum alloys, thereby avoiding the risk of loss in mechanical properties in the metallic layer associated with high temperature curing in traditional alloys. Embodiments of the present invention may also present strength increases and weight savings capabilities through utilization of composite materials with very high modulus of elasticity and nanostructured alloys of relatively high strength. Furthermore, because embodiments of the present invention are capable of being adapted to handle a variety of stresses and curing temperatures, such embodiments are suitable for use in association with multiple configurations.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the inventions should be determined entirely by reference to the claims that follow.

1. A nanostructure aluminum fiber metal laminate, comprising:
at least one pair of nanostructure metallic layers; and
at least one composite layer formed between the nanostructure metallic layers, the composite layer including a plurality of fibers.

2. The laminate according to claim 1, wherein the nanostructure metallic layers comprise a heat-resistant nanostructure metal, the nanostructure metal further comprising nanophase aluminum.

3. The laminate according to claim 1, wherein the plurality of fibers includes at least one of an organic polymer fiber and a diimidazo pyridinylene fiber.

4. The laminate according to claim 3, wherein the plurality of fibers further includes at least one of a galvanically non-reactive fiber and an electrically non-conductive fiber.

5. The laminate according to claim 1, wherein the composite layer comprises a resin matrix.

6. The laminate according to claim 1, wherein the nanostructure metallic layer comprises a first nanostructure metallic layer, the laminate further comprising a second nanostructure metallic layer, the fiber layer being disposed between the first and second nanostructure metallic layers and coupled thereto.

7. The laminate according to claim 6, wherein the fiber layer includes a plurality of partial portions abutted together.

8. The laminate according to claim 1, wherein the fiber layer is bonded to the nanostructure metallic layer by an adhesive resin.

9. A nanostructure aluminum fiber metal laminate, comprising:
at least one pair of nanostructure metallic layers;
at least one composite layer formed between the nanostructure metallic layers, the composite layer including a plurality of fibers; and
an approximately hollow core layer disposed between a pair of fiber metal composite layers.

10. The laminate according to claim 9, wherein the nanostructure metallic layers comprise a heat-resistant nanostructure metal, the nanostructure metal further comprising nanophase aluminum.

11. The laminate according to claim 9, wherein the plurality of fibers includes at least one of an organic polymer fiber and a diimidazo pyridinylene fiber.

12. The laminate according to claim 11, wherein the plurality of fibers further includes at least one of a galvanically non-reactive fiber and an electrically non-conductive fiber.

13. The laminate according to claim 9, wherein the nanostructure metallic layer comprises a first nanostructure metallic layer, the laminate further comprising a second nanostructure metallic layer, the fiber layer being disposed between the first and second nanostructure metallic layers and coupled thereto.

14. The laminate according to claim 9, wherein the hollow core layer comprises a honeycomb hollow core.

15. A method of forming a nanostructure aluminum fiber metal laminate composite, comprising:
providing at least one nanostructure metallic layer;
aligning a plurality of fibers into a fiber layer to form at least one composite layer; and
bonding the composite layer to the nanostructure metallic layer.

16. The method according to claim 15, wherein providing at least one nanostructure metallic layer comprises providing nanophase aluminum.

17. The method according to claim 16, wherein providing further comprises providing a mechanically alloyed aluminum alloy powder submerged in a liquid nitrogen.

18. The method according to claim 15, further comprising pretreating the nanostructure metallic layer, including at least one of a sol gel surface treatment and a phosphoric acid anodizing.

19. The method according to claim 15, wherein bonding the composite layer to the nanostructure metallic layer comprises bonding partial layers of the composite layer to the nanostructure metallic layer.

20. The method according to claim 15, further comprising bonding the composite layer to the nanostructure metallic layer using an adhesive resin.

21. The method according to claim 15, wherein bonding the composite layer to the nanostructure metallic layer includes forming a hollow core disposed between a pair of fiber metal composite layers, the hollow core further comprising a honeycomb hollow core.

22. A method of producing a nanostructure composite material, comprising:
producing a nanostructure metallic layer by mechanically alloying an metallic alloy powder in a solution of liquid nitrogen;
pretreating the mechanically alloyed nanostructure metallic layer;
interspersing the pretreated nanostructure metallic layer with a composite layer, the composite layer comprising of a plurality of fibers; and
applying an adhesive resin to bond the nanostructure metallic layer to the composite fiber layer to form a nanostructure fiber metal laminate composite layer.

23. The method of claim 22, wherein producing a nanostructure metallic layer comprises cryomilling a nanophase aluminum layer.

24. The composite of claim 22, wherein interspersing includes partial layers of at least one pair nanostructure metallic layer and at least one fiber layer.

25. The composite of claim 22, wherein the bonding of the nanostructure metallic layer to the fiber layer comprises forming a hollow core disposed between the nanostructure fiber metal laminate composite layers, including a honeycomb hollow core.
